(19) United States
(12) Patent Application Publication
(10) Pub. No.: US 2026/0253237 A1
(43) Pub. Date: Aug. 27, 2026

(54) SYNTHETIC DATA ENGINE AND AI ARCHITECTURE FOR END TO END MULTI-FRAME SUPER-RESOLUTION

(71) Applicant: Samsung Electronics Co., Ltd., Suwon-si (KR)

(72) Inventors: Fadeel Sher Khan, Austin, TX (US); Joshua Peter Ebenezer, Plano, TX (US); Hamid Sheikh, Allen, TX (US)

(21) Appl. No.: 19/449,250

(22) Filed: Jan. 14, 2026

Related U.S. Application Data
(60) Provisional application No. 63/762,293, filed on Feb. 24, 2025.

(51) Int. Cl. G06T 7/33; G06T 3/4053; G06T 5/50; G06T 5/60; G06T 11/00

(52) U.S. Cl. CPC G06T 7/337; G06T 3/4053; G06T 5/50; G06T 5/60; G06T 11/00; G06T 2207/20016; G06T 2207/20081; G06T 2207/20221; G06T 2210/36

(57) ABSTRACT

A method includes obtaining a multi-frame input image having a first image resolution from a first optical sensor at a multi-frame super-resolution (MFSR) model. The method also includes generating an output image using the MFSR model based on the multi-frame input image, the output image having an output image resolution higher than the first image resolution. Generating the output image using the MFSR model based on the multi-frame input image may include generating input features based on the multi-frame input image using a multi-scale base frame enhancement (BFE) and generating a fused feature output using multi-frame feature fusion based on the input features. Generating the output image using the MFSR model based on the multi-frame input image may also include constructing an intermediate output image using a residual feature block using the fused feature output and generating the output image by upsampling the intermediate output image.

### CROSS-REFERENCE TO RELATED APPLICATION AND PRIORITY CLAIM

This application claims priority under 35 U.S.C. § 119(e) to U.S. Provisional Patent Application No. 63/762,293 filed on Feb. 24, 2025, which is hereby incorporated by reference in its entirety.

### TECHNICAL FIELD

This disclosure relates generally to image processing. More specifically, this disclosure relates to a synthetic data engine and AI architecture for end to end multi-frame super-resolution.

### BACKGROUND

Natural hand tremors are present at the moment of handheld phone camera capture, so when multiple frames are recorded in sequence, each frame exhibits slight spatial differences due to the user's motion. As a result, a multi-frame capture of a scene preserves more spatial information than any single frame of that same scene. Multi-frame super-resolution (MFSR) seeks to exploit this property by extracting additional spatial detail from individual frames to reconstruct a substantially higher-resolution final image. In practice, such methods often rely on artificial intelligence models trained to produce high-resolution single-frame outputs from multiple lower-resolution inputs of the same scene. However, developing these systems is challenging because it is difficult to assemble datasets containing perfectly aligned pairs of low-resolution and high-resolution images.

### SUMMARY

This disclosure relates to a synthetic data engine and AI architecture for end to end multi-frame super-resolution.

In a first embodiment, a method includes obtaining a multi-frame input image having a first image resolution from a first optical sensor at a multi-frame super-resolution (MFSR) model. The method also includes generating an output image using the MFSR model based on the multi-frame input image, the output image having an output image resolution higher than the first image resolution.

In a second embodiment, an electronic device includes at least one processor configured to obtain, by at least one processor of an electronic device, a multi-frame input image having a first image resolution from a first optical sensor at a MFSR model. The at least one processor is also configured to generate an output image using the MFSR model based on the multi-frame input image, the output image having an output image resolution higher than the first image resolution.

In a third embodiment, a non-transitory machine-readable medium contains instructions that when executed cause at least one processor of an electronic device to obtain a multi-frame input image having a first image resolution from a first optical sensor at a MFSR model. The non-transitory machine-readable medium also contains instructions that when executed cause at least one processor to generate an output image using the MFSR model based on the multi-frame input image, the output image having an output image resolution higher than the first image resolution.

Any single one or any combination of the following features may be used with the first, second, or third embodiment. Generating the output image using the MFSR model based on the multi-frame input image may include generating input features based on the multi-frame input image using a multi-scale base frame enhancement (BFE) and generating a fused feature output using multi-frame feature fusion based on the input features. Generating the output image using the MFSR model based on the multi-frame input image may also include constructing an intermediate output image using a residual feature block using the fused feature output and generating the output image by upsampling the intermediate output image. The multi-scale BFE may be configured to generate a residual difference computation based on a difference between features of a non-reference frame of the multi-frame input image and a reference frame of the multi-frame input image. The multi-scale BFE may be additionally configured to generate aligned features aligning features of the non-reference frame to the reference frame based on the residual difference computation using a hybrid gated attention model. Generating the fused feature output using the multi-frame feature fusion based on the input features may include generating channel features by reshaping the aligned features into a channel dimension, reducing a dimensionality of the channel features using a gated attention model, extracting contextual information from the channel features, determining a weight of the channel features based on the contextual information, and converting the channel features back to an original input shape. Before generating the output image by upsampling the intermediate output image, a loss may be calculated between a ground truth and the intermediate output image and backpropagated to update the MFSR model. The MFSR model may be trained to align features using a training pair having short-exposure frames and long-exposure frames, wherein a source image of the short-exposure frames may be different from a source image of the long-exposure frames. The MFSR model may be trained based on a database of homography matrices representing a transformation from a reference frame to a non-reference frame.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example network configuration including an electronic device according to this disclosure;

FIG. 2 illustrates an example multi-frame super resolution training architecture supporting end to end multi-frame super-resolution using a synthetic data engine and AI architecture according to this disclosure;

FIGS. 3A and 3B illustrate an example flow diagram of a synthetic data engine and AI architecture for end to end multi-frame super-resolution according to this disclosure;

FIG. 4 illustrates an example AI model architecture supporting image processing for end to end multi-frame super-resolution according to this disclosure;

FIG. 5 illustrates another example AI model architecture supporting image processing for end to end multi-frame super-resolution according to this disclosure;

FIG. 6 illustrates an example alternate realization process supporting image processing for end to end multi-frame super-resolution according to this disclosure;

FIG. 7 illustrates an example base frame enhancement (BFE) architecture supporting image processing for end to end multi-frame super-resolution according to this disclosure;

FIG. 8 illustrates an example hybrid feature alignment architecture for a BFE architecture supporting image processing for end to end multi-frame super-resolution according to this disclosure;

FIG. 9 illustrates an example multi-frame feature fusion architecture supporting image processing for end to end multi-frame super-resolution according to this disclosure;

FIG. 10 illustrates an example method for image processing using a synthetic data engine and AI architecture for end to end multi-frame super-resolution according to this disclosure; and

FIG. 11 illustrates example images with and without image processing using a synthetic data engine and AI architecture for end to end multi-frame super-resolution according to this disclosure.

### DETAILED DESCRIPTION

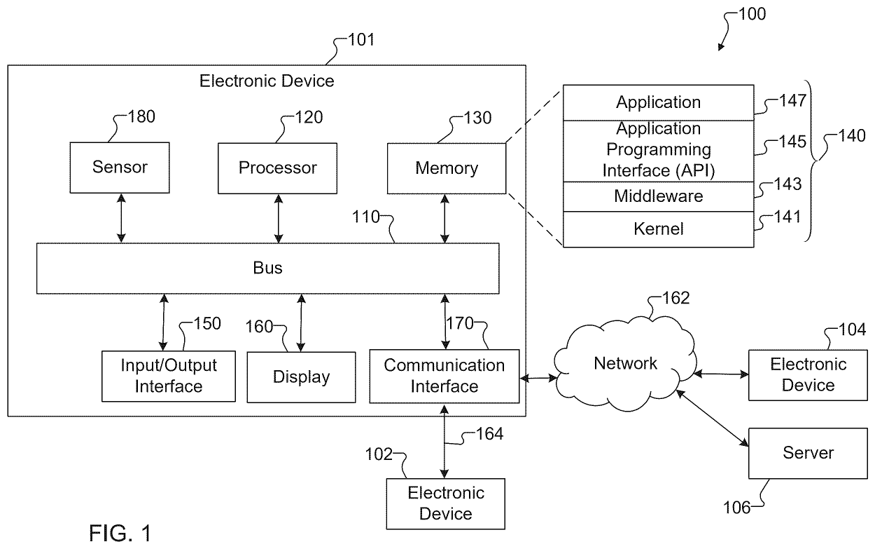

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As noted above, natural hand tremors are present at the moment of handheld phone camera capture, so when multiple frames are recorded in sequence, each frame exhibits slight spatial differences due to the user's motion. As a result, a multi-frame capture of a scene preserves more spatial information than any single frame of that same scene. Multi-frame super-resolution (MFSR) seeks to exploit this property by extracting additional spatial detail from individual frames to reconstruct a substantially higher-resolution final image. In practice, such methods often rely on artificial intelligence models trained to produce high-resolution single-frame outputs from multiple lower-resolution inputs of the same scene. However, developing these systems is challenging because it is difficult to assemble datasets containing perfectly aligned pairs of low-resolution and high-resolution images.

Capturing the same scene simultaneously with a low-resolution camera sensor and a high-resolution camera sensor cannot be achieved with sub-pixel accuracy, since any attempt to do so will result in at least some sub-pixel offset or misalignment even when the two sensors are mounted side by side. In practical settings, the only spatial differences between the lower-resolution inputs and the higher-resolution final output arise from handheld motion by the device user and motion within the scene. Accordingly, the creation of such a dataset requires the use of synthetic data generation techniques.

A basic synthetic data generation method for producing low-resolution RAW input frames and high-resolution ground-truth RGB images applies synthetic motion and synthetic noise to a high-resolution DSLR image using randomly sampled motion and noise parameters and then performs downsampling. In this approach, the input images are derived from a static, for example, no-motion ground-truth image. The noise is entirely synthetic, and the motion is restricted to random rotations and translations, which may not fully reflect real-world conditions.

Once pairs of low-resolution input frames and high-resolution ground-truth frames have been generated, a model can be trained in an end-to-end manner to map the low-resolution frames to high-resolution outputs. In this context, end-to-end denotes the transformation from RAW Bayer color filter array inputs to processed RGB output images.

This disclosure provides techniques for image processing with end to end multi-frame super-resolution using a synthetic data engine and AI architecture. As described in more detail below, this disclosure includes obtaining a multi-frame input image having a first image resolution from a first optical sensor at a MFSR model. The method also includes generating an output image using the MFSR model based on the multi-frame input image, the output image having an output image resolution higher than the first image resolution.

This disclosure introduces significant improvements to MFSR by using a synthetic data generation engine that produces low-resolution frames emulating handheld capture motion from both noisy and clean high-resolution static images taken on a tripod. Additionally, this disclosure sets out an end-to-end AI pipeline that aligns multiple low-resolution frames to reconstruct a higher-resolution image. Together, this disclosure deliver an AI solution that can produce a clean, higher-resolution image from multiple noisy, lower-resolution inputs, with performance that can be scaled through the use of synthetic data generation.

In this way, the described techniques can be used to generate improved images of scenes, such as images having improved image quality. Note that while these techniques are often described below as being used for multi-frame super-resolution, the same or similar techniques may be used to perform other image processing operations, such as demosaicing, denoising, and de-blurring.

FIG. 1 illustrates an example network configuration 100 including an electronic device according to this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to a synthetic data engine and AI architecture for end to end multi-frame super-resolution.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to a synthetic data engine and AI architecture for end to end multi-frame super-resolution. These functions can be performed by a single application or by multiple applications that each conduct one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high-definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving a separate network. The electronic device 101 can also be an augmented reality wearable device, such as eyeglasses, which include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to multi-frame super-resolution using a synthetic data engine and AI architecture.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

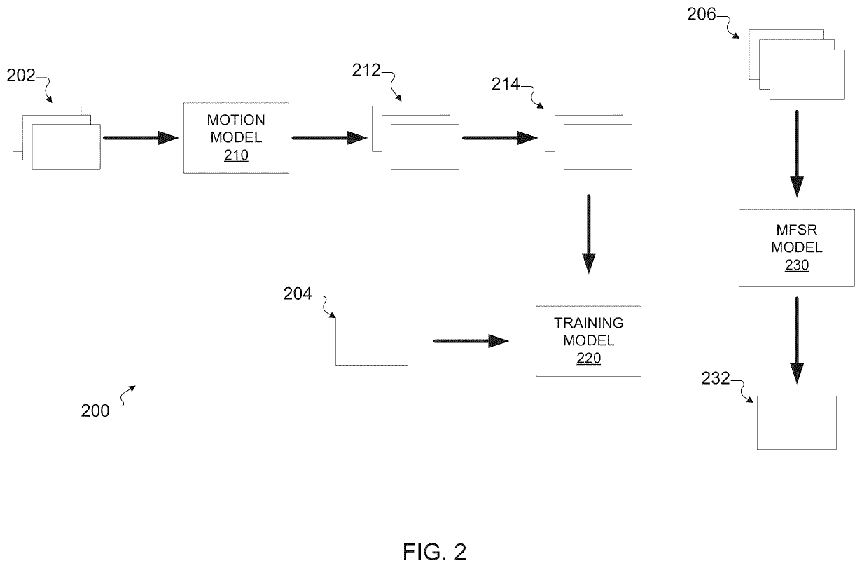

FIG. 2 illustrates an example MFSR training architecture 200 supporting end to end multi-frame super-resolution using a synthetic data engine and AI architecture according to this disclosure.

The MFSR training architecture 200 first synthetically generates independent low-resolution and high-resolution images of the same scene with sub-pixel accuracy, ensuring that the only differences arise from real-world factors, for example handheld motion and sensor-specific noise rather than artificial random motion and random noise.

As shown in FIG. 2, the MFSR training architecture 200 is configured to receive high-resolution (HR) frames 202 at a motion model 210. The HR frames 202 may be, for example, frames from a short exposure image. The motion model 210 is a motion model that is configured to generate synthetic frames 212 that mimics real-life handheld motion such that the synthetic frames 212 include synthetic motion noise. In other words, the HR frames 202 are subjected to motion modeling that reflects handheld motion using homographies derived from an external dataset of real handheld captures rather than relying on random rotations and translations. The motion modeling in the motion model 210 is performed at the patch level to avoid unnecessary interpolation or padding.

The synthetic frames 212 are then downsampled to generate downsampled frames 214 to yield low-resolution outputs that incorporate realistic handheld motion. The downsampled frames 214 are provided to an MFSR training model 220. The MFSR training model 220 also receives a ground truth frame 204, such as from a long exposure image.

The MFSR training model 220 uses the downsampled frames 214 and the ground truth frame 204 for training. Once trained, the MFSR training model 220 may be implemented as an MFSR model 230. In use, the MFSR model 230 is configured to receive noisy RAW frames 206, such as from a handheld capture, to generate a HR clean image 232.

The MFSR training architecture 200 begins by capturing identical static short-exposure noisy frames and a long-exposure clean frame, such as on a tripod. These frames are aligned and differ only due to sensor-specific noise. The motion model 210 includes a synthetic data generation engine that is then applied to produce low-resolution RAW inputs (such as the downsampled frames 214) and high-resolution ground-truth images (such as the ground truth frame 204). After data generation, the MFSR training architecture 200 employs the MFSR training model 220 that aligns the RAW Bayer multi-frames and extracts spatial information to produce a final high-resolution RGB image. In doing so, the MFSR training model 220 natively learns traditional image processing operations, such as demosaicing, allowing the MFSR training model 220 to be robust to object motion and effectively handle ghosting and noise artifacts. The synthetic data generation process (such as the motion model 210 and downsampling) can be used to build a multi-frame dataset for a range of multi-frame photography applications, for example denoising and image restoration. The MFSR model 230 may perform S-times super-resolution on any RAW Bayer input, such as two times, to convert a 12 MP Bayer input to a 50 MP RGB output, or to convert a 50 MP Bayer input to a 200 MP RGB output.

The MFSR training architecture 200 departs from current methods by using a multi-frame capture of high-resolution short-exposure frames and a long-exposure frame to generate independent inputs and ground-truth images. The HR frames 202 undergo additional processing to create low-resolution synthetic frames, while the high-resolution long-exposure image is used to produce the ground truth (such as the ground truth frame 204). All frames may be captured on a tripod to eliminate handheld and object motion so that the only inherent differences are due to sensor-specific noise rather than random noise introduced by conventional pipelines.

Although FIG. 2 illustrates an example MFSR training architecture 200 supporting end to end multi-frame super-resolution using a synthetic data engine and AI architecture, various changes may be made to FIG. 2. For example, various components and functions in FIG. 2 may be combined, further subdivided, replicated, omitted, or rearranged according to particular needs. Also, one or more additional components and functions may be included if needed or desired.

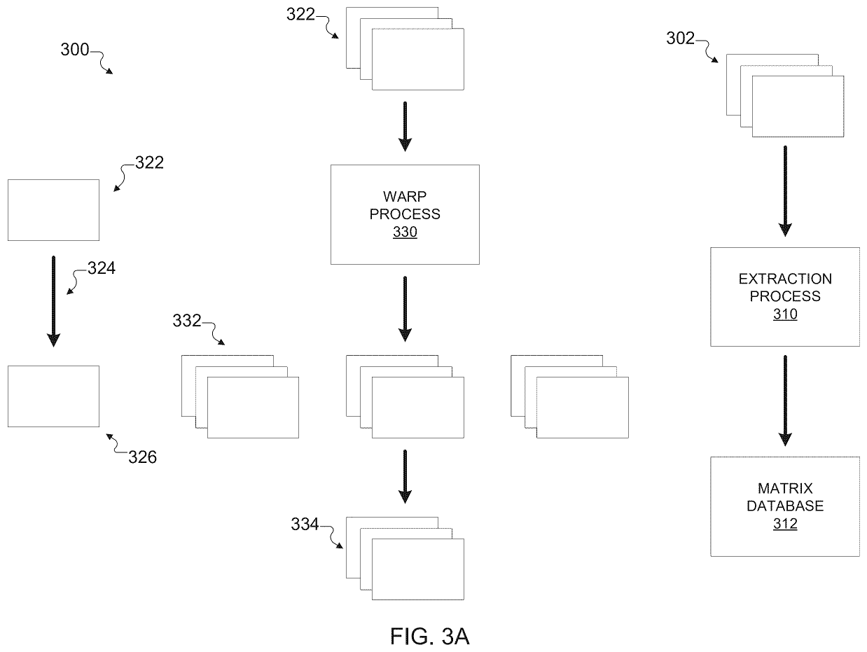

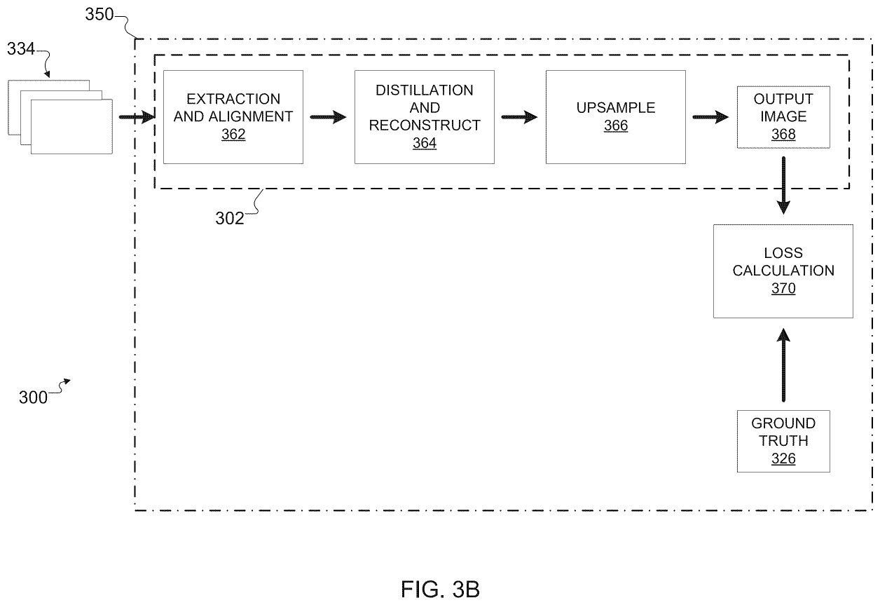

FIGS. 3A-3B illustrate an example flow diagram 300 for training of a synthetic data engine and AI architecture for end to end multi-frame super-resolution according to this disclosure. For ease of explanation, the flow diagram 300 is described as involving the use of the electronic device 101 in the network configuration 100 of FIG. 1. However, the flow diagram 300 may be used with any other suitable device (such as the server 106) or a combination of devices (such as the electronic device 101 and the server 106) and in any other suitable system(s).

As shown in FIG. 3A, the flow diagram 300 may be implemented in the electronic device 101, such as by using the processor 120. The flow diagram 300 includes receiving burst frames 302. All homography matrices are extracted from the burst frames 302 that represent the perspective warp required to transform a base frame into a handheld burst frame for all multi-frame captures obtained in an independent handheld data collection. To do so, a homography matrix extraction process 310 is performed on the burst frames 302 to generate homography matrices for each of the burst frames 302. The homography matrices are then stored in a homography matrix database 312.

The flow diagram 300 may then receive HR image frames 322, such as short exposure frames, and perform a tetra-to-RGB conversion 324 using any desired demosaicing method to generate a ground truth frame 326. Additionally, the HR image frames 322 may be used in a warp process 330 along with the homography matrix database 312 to generate burst frames 332. For example, random patches are generated from each HR image frame 322 together with the ground truth frame 326. For each paired patch, a homography matrix is sampled at random from the homography matrix database 312, and a perspective warp is applied to the HR image frame 322 around the frame center. The center of each paired patch is cropped, and the HR image frame 322 is downsampled to low resolution to generate downsampled burst frames 334 using bicubic interpolation to produce a one-to-one (1:1) image pair. The downsampled burst frames 334 are then converted from RGB space back to Bayer RAW space by mosaicking.

As shown in FIG. 3B, the flow diagram 300 also includes providing the downsampled burst frames 334 to an AI model training stage 350 and, in particular, to an inference stage 360 of the AI model training stage 350. The downsampled burst frames 334 are used in a feature extraction and alignment process 362 to extract and align features to a base frame, a multi-frame feature distillation and reconstruction process 364 to reconstruct an image based on the features, and an upsampling process 366 to upsample the reconstructed image to a desired resolution to generate an output image 368.

Multi-scale feature extraction is performed on the multi-frame low-resolution inputs. The features for each frame are aligned to the base frame to compensate for motion. Residuals are then computed for each feature with respect to the base frame. For example, the base frame remains unchanged while the remaining frames are replaced by their differences from the base frame to account for object motion between frames.

The image is reconstructed using dense multi-frame residual feature distillation. Up-sampling in the feature space follows to achieve the target resolution from H by W to S times H by S times W, and the model outputs a three-channel image representing RGB.

The output image 368 may then be provided to a loss calculation and backpropagation process 370, along with a ground truth frame, such as the ground truth frame 326, to calculate a loss. The loss is then backpropagated to update the AI model.

The training objective measures loss between the ground truth frame 326 and the output image 368. The loss calculation and backpropagation process 370 applies mean absolute error (L1 loss), such as by averaging the absolute difference between pixel values of the output image 368 and the ground truth frame 326, and perceptual visual geometry group (VGG) loss, also known as learned perceptual image patch similarity (LPIPS) loss, during initial pre-training.

Additionally or alternatively, the multi-frame feature distillation and reconstruction process 364 may also include a generative adversarial network (GAN) loss to fine-tune the MFSR model 230 after initial pretraining on L1 and VGG losses. Conventional multi-frame super-resolution techniques rely on variations of L1 and VGG losses to measure how model outputs compare to ground truth images and to train the MFSR model 230 accordingly. Conventional single image super-resolution techniques have also used generative adversarial network and gradient losses to improve training, but comparable methods have not been adopted for multi-frame super-resolution. After a specified number of epochs, the flow diagram 300 then applies GAN and gradient losses to fine-tune the MFSR model 230 and improve performance without adding computational cost.

A relativistic GAN loss is used once the MFSR model 230 has been pretrained. During epochs from zero through N, the total loss for training is L1 loss plus VGG loss. From epoch N through the end of training, the total loss becomes L1 loss plus VGG loss plus GAN loss plus gradient loss. Because loss functions and models are used only during training and not during inference, this strategy does not increase computational cost or complexity at inference time but can significantly improve performance. The approach leverages the strength of conventional multi-frame super-resolution loss functions for general performance and then employs specific GAN and gradient losses to emphasize characteristics such as texture and detail retention.

Creating a dataset of one-to-one aligned pairs of low-resolution and high-resolution images is inherently challenging. Capturing the same scene at the same time with both a low-resolution and a high-resolution sensor does not allow sub-pixel accuracy, for example even side-by-side sensors will introduce at least a small sub-pixel offset or misalignment. As a result, any aligned pairs are unlikely to be independent, for example they are typically generated from the same source image, and any independent pairs are unlikely to be aligned. The flow diagram 300 resolves this problem by using short- and long-exposure frames of static scenes to produce a dataset of aligned and independent images for multi-frame super resolution. In this framework, the source images are independent while the alignment is accurate, which provides high-quality supervision for learning frame alignment and fusion under realistic handheld motion and sensor noise conditions.

Although FIGS. 3A-3B illustrate one example of flow diagram 300 of a synthetic data engine and AI architecture for end to end multi-frame super-resolution and related details, various changes may be made to FIGS. 3A-3B. For example, the order of multi-frame feature distillation, image reconstruction, and up-sampling can vary, for instance 1-2-3, 1-3-2, 3-1-2, or 2-1-3. The flow diagram 300 can use different types of feature distillation blocks, including residual feature distillation, residual-in-residual-dense blocks, transformer blocks, and channel attention blocks. Additionally, various components and functions in FIGS. 3A-3B may be combined, further subdivided, replicated, omitted, or rearranged according to particular needs. Also, one or more additional components and functions may be included if needed or desired. In addition, while images in a specific domain (namely the RGB domain) are described above, image data in any other suitable domain may be received and/or generated.

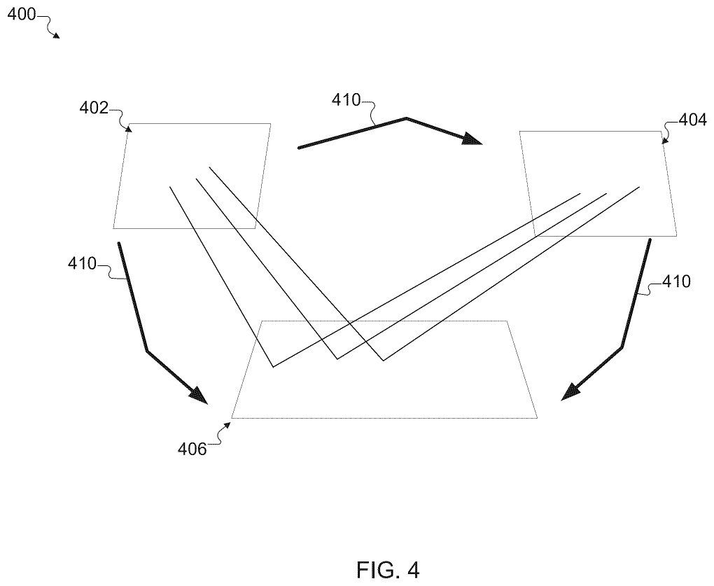

FIG. 4 illustrates another example homography extraction process 400 supporting image processing for end to end multi-frame super-resolution according to this disclosure. For example, the homography extraction process 400 may be used as part of the flow diagram 300 of FIGS. 3A-3B, such as to generate the homography matrix database 312. The homography extraction process 400, however, may be used in other suitable architectures.

As shown in FIG. 4, the homography extraction process 400 includes a first image 402, a second image 404 projecting onto a planar surface 406 based on homography matrices 410.

The flow diagram 300 of FIG. 3 introduces an independent database of homography matrices (such as the homography matrix database 312) that represent the transformations from a base frame to a handheld non-reference frame in a multi-frame capture, which are then used to warp static images. Using the homography matrices produces final input frames that differ only in handheld motion and sensor-specific noise that varies for each captured frame. In all other respects the frames are aligned, as would be the case in a real-world multi-frame image capture.

The homography extraction process 400 extracts all homography matrices 410 that encode the perspective warp needed to transform a base frame into each handheld burst frame for all available multi-frame captures gathered in an independent handheld data collection.

The homography extraction process 400 includes computing a homography matrix 410 for each pair of base and non-reference frames. Each element of the homography matrix 410 specifies the transformation that maps a base frame to its corresponding non-reference frame. If a point at coordinates (x1, y1) lies in the base frame, then the corresponding coordinates (x2, y2) in a reference frame can be determined through a perspective warp defined by the homography matrix 410, denoted as H_{F}, as shown below.

$$[ \begin{matrix}{x}_{2} \\ {y}_{2} \\ 1\end{matrix} ] = {H}_{F} [ \begin{matrix}{x}_{1} \\ {y}_{1} \\ 1\end{matrix} ] , where ,$$

$${H}_{F} = [ \begin{matrix}{h}_{11} & … & {h}_{13} \\ ⋮ & ⋱ & ⋮ \\ {h}_{31} & … & 1\end{matrix} ] .$$

In practice, a database (such as the homography matrix database 312) is created that contains the homography matrices 410 for all base frame and non-reference frame pairs. The process then randomly samples a homography matrix 410 from this database and uses the homography matrix 410 as the parameter set for a perspective warp applied to a static non-reference frame image input to induce handheld motion.

Although the mathematics of homographies is well established, conventional workflows for multi-frame handheld image capture do not typically use homography matrices 410 to model transformations between frames. Most synthetic data generation techniques instead rely on random transformations such as rotations and translations to emulate handheld motion. In contrast, this disclosure builds a database of homography matrices 410 that define the exact transformation between a base frame and each of its related, non-reference frames. This method closely models true handheld motion.

Although FIG. 4 illustrates a homography extraction process 400 supporting image processing for end to end multi-frame super-resolution, various changes may be made to FIG. 4. For example, various components and functions in FIG. 4 may be combined, further subdivided, replicated, omitted, or rearranged according to particular needs. Also, one or more additional components and functions may be included if needed or desired.

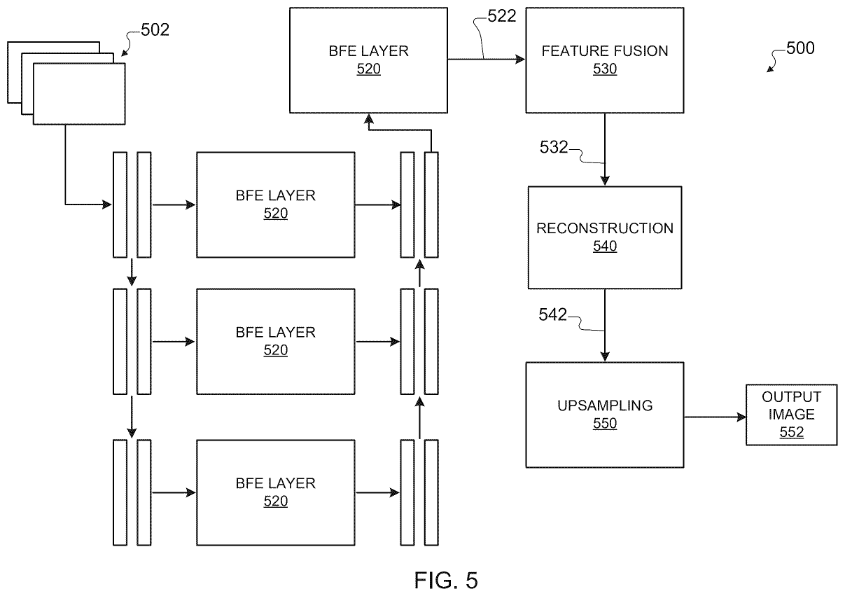

FIG. 5 illustrates an example AI model architecture 500 supporting image processing for end to end multi-frame super-resolution according to this disclosure. For example, the AI model architecture 500 may be used as part of the MFSR model 230 of FIG. 2. The homography extraction process 400, however, may be used in other suitable architectures.

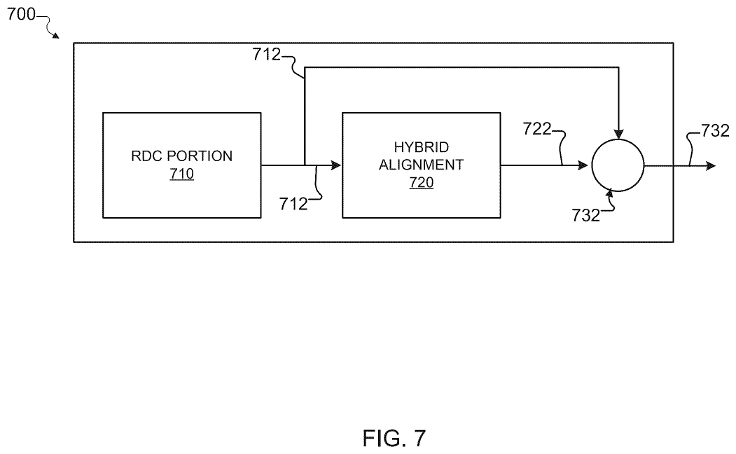

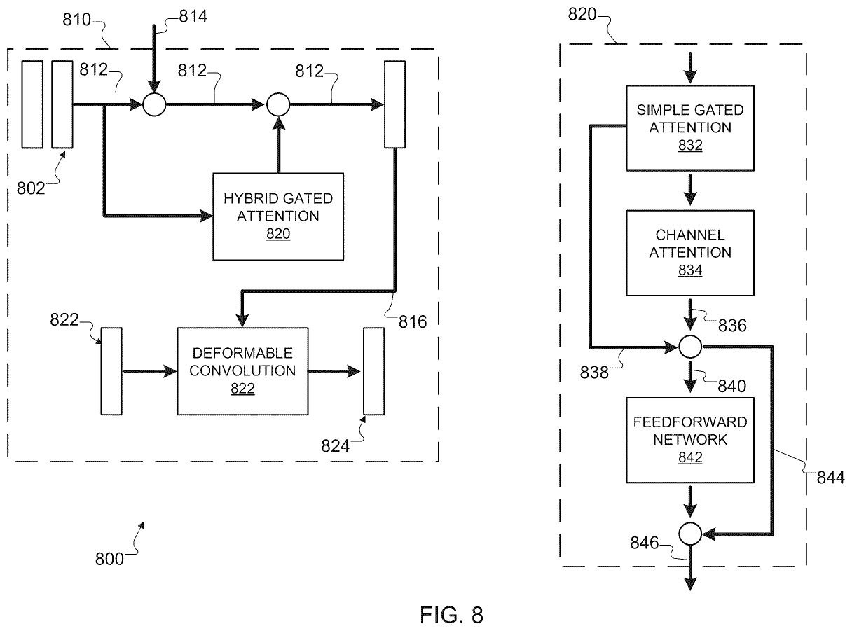

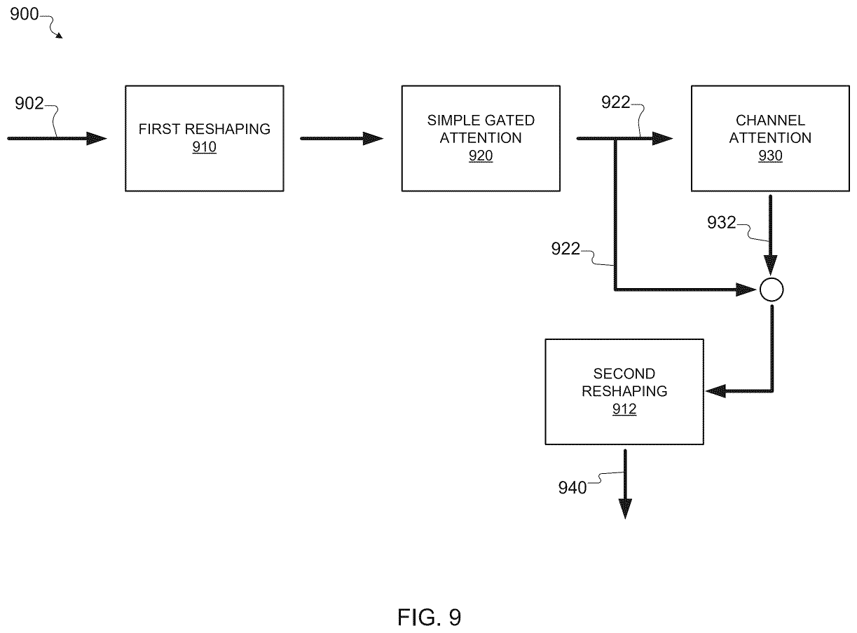

As shown in FIG. 5, the AI model architecture 500 includes an autoencoder 510, such as a U-Net architecture, configured to receive RAW burst frames 502. The autoencoder 510 includes encoder layers 512 and decoder layers 514 having BFE layers 520 between each encoder-decoder layer pair. The RAW burst frames 502 may be initially convoluted, such as before processing at a first autoencoder 510. Each successive encoder layer 512 may include an attention weighted processing of the RAW burst frames 502 (such as hybrid gated attention weighting) before processing. The autoencoder 510 encodes the RAW burst frames 502 using the BFE layers 520 at each layer then decodes the output of the BFE layers 520 using to generate offset features provided to a BFE layers 520 of another encoder-decoder layer. The autoencoder 510 (discussed further in FIGS. 7 and 8), outputs to a multi-frame feature fusion 530 (discussed further in FIG. 9) for fusion and reshaping of the frame and, subsequently, to an image reconstruction model 540 for image reconstruction to generate a reconstructed image 542. The reconstructed image 542 may be upsampled using an upsampling process 550 to generate an output image 552.

Although FIG. 5 illustrates an example AI model architecture 500 supporting image processing for end to end multi-frame super-resolution, various changes may be made to FIG. 5. For example, residual skip connections with the base frame, which are used in the current embodiment only for feature alignment, can be extended to other AI blocks depending on complexity. The base frame, set to frame 0 in the current embodiment, may be assigned to any frame. Up-sampling methods can vary as well and may include interpolation methods, for example bicubic, bilinear, or nearest neighbor, as well as pixel shuffle or unshuffle based approaches. Attention mechanisms can also vary, including transformer-based self-attention and cross-attention, and convolution-based channel or spatial attention. Finally, multi-scale feature alignment can be adjusted. The current embodiment traverses three scales from H to H/4, but the scales can be modified, for example from H to H/8 or H to H/16. Additionally, various components and functions in FIG. 5 may be combined, further subdivided, replicated, omitted, or rearranged according to particular needs.

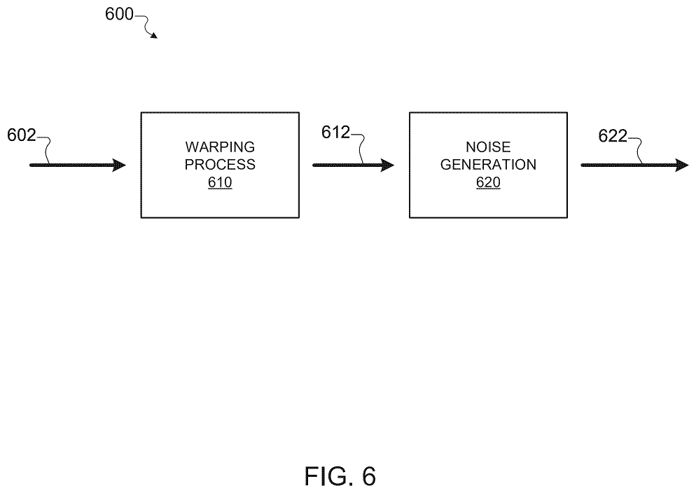

FIG. 6 illustrates an example alternate realization process 600 supporting image processing for end to end multi-frame super-resolution according to this disclosure. For example, the alternate realization process 600 may be used as part of the MFSR training architecture 200 of FIG. 2, such as to generate the synthetic frames 212. The alternate realization process 600, however, may be used in other suitable architectures.

There are circumstances in which adding noise to the MFSR model 230, in addition to handheld motion, is necessary. This need arises when no short-exposure high-resolution frames are available, or when the nearest neighbor interpolation warp in or the bicubic down-sampling restructures or removes the original noise. In these alternative implementations, synthetic noise tailored to the specific sensor may be introduced.

As shown in FIG. 6, the alternate realization process 600 includes receiving a high-resolution (HR) image 602 having N frames and subjecting the HR image 602 to a warping process 610. The warping process 610 may include warping each frame in the RGB space based on sampled homographies to generate warped frames 612. The warped frames 612 undergo a frame noise generation process 620, where metadata of each frame is used to generate frame and sensor-specific noise, to generate a noisy HR frame 622.

Although FIG. 6 illustrates an example alternate realization process 600 supporting image processing for end to end multi-frame super-resolution, various changes may be made to FIG. 6. For example, various components and functions in FIG. 6 may be combined, further subdivided, replicated, omitted, or rearranged according to particular needs. Also, one or more additional components and functions may be included if needed or desired.

FIG. 7 illustrates an example base frame enhancement (BFE) architecture 700 supporting image processing for end to end multi-frame super-resolution according to this disclosure. For example, the BFE architecture 700 may be used as part of the AI model architecture 500 of FIG. 5, such as in the BFE layers 520. The BFE architecture 700, however, may be used in other suitable architectures.

Residuals and skip connections are added with respect to the base frame, which emphasizes the base frame during feature and frame alignment. Conventional AI methods for multi-frame super-resolution tend to blend all frames in a multi-frame capture, and in the presence of object motion, the conventional blending approach often produces ghosting artifacts. The BFE architecture 700 applies attention and deformable convolutions to residuals of the non-reference frames so that the base frame is fully represented while all other frames contribute only as residual information. In other words, each non-reference frame contributes only a difference between the non-reference frame and the base frame rather than the entire non-reference frame, which increases the relative weight of the base frame as the MFSR model 230 learns alignment, reconstruction, and upsampling. As such, the BFE architecture 700 includes residual difference computation in an RDC portion 710 as shown in FIG. 7. The RDC portion 710 is configured to receive a base frame (such as from encoder layers 512) and provides features to a hybrid feature alignment portion 720.

For the features of each non-reference frame with dimension 1×F×H×W, the BFE architecture 700 computes a residual by subtracting the base-frame features from the corresponding features of the non-reference frame.

The hybrid feature alignment portion 720 generates aligned features that are combined with a skip connection 712 from the RDC portion 710 using a combination function 730 to generate a BFE output 732.

Although FIG. 7 illustrates an example BFE architecture 700 supporting image processing for end to end multi-frame super-resolution, various changes may be made to FIG. 7. For example, various components and functions in FIG. 7 may be combined, further subdivided, replicated, omitted, or rearranged according to particular needs. Also, one or more additional components and functions may be included if needed or desired.

FIG. 8 illustrates an example hybrid feature alignment architecture 800 for a BFE architecture supporting image processing for end to end multi-frame super-resolution according to this disclosure. For example, the hybrid feature alignment architecture 800 may be used as part of the BFE architecture 700 of FIG. 7, such as for the hybrid feature alignment portion 720. The hybrid feature alignment architecture 800, however, may be used in other suitable BFE architectures.

As shown in FIG. 8, the hybrid feature alignment architecture 800 includes a hybrid feature alignment portion 810. The hybrid feature alignment portion 810 includes convolution layers 812 configured to receive input frames input frames 802 (such as a base frame and non-reference frame). The output of convolution layers 812, such as an output of a first convolution layer, may be combined with previous offset features 814 before further convolution. The convolution layers 812 are coupled to a hybrid gated attention layer deformable convolution layer 820 as part of a skip connection. The hybrid gated attention layer deformable convolution layer 820 receives output from a convolution layers 812, such as a first convolution layer, to generate an attention-weighted output. The attention-weighted output is combined with an output of a subsequent convolution layer before undergoing another convolution to generate offset features 816. The offset features 816 may be provided to a deformable convolution layer 822 along with non-reference frames 824 to generate aligned features 826.

The hybrid gated attention layer deformable convolution layer 820 may include a simple gated attention layer 832 configured to receive a convoluted input convoluted input 830 (such as from the convolution layers 812). The simple gated attention layer 832 outputs to a channel attention layer 834 to generate an attention-weighted output. The attention-weighted output may undergo a convolution in a convolution layer 836 before being combined with the original convoluted input 830 (via a first skip connection 838). The combined output may then be subjected to a layer normalization function 840 before being provided to a gated feedforward network 842. The output of the gated feedforward network 842 may be combined with the attention-weighted output using a second skip connection 844 to generate a hybrid gated attention output 846.

Due to the two gated attention mechanisms, the hybrid feature alignment architecture 800 more effectively extracts salient contextual information from the fused features of the base frame and the non-reference frame, producing offset features. Using these offset features, the non-reference frame is subsequently aligned to the base frame through deformable convolution.

Although FIG. 8 illustrates an example hybrid feature alignment architecture 800 for a BFE architecture supporting image processing for end to end multi-frame super-resolution, various changes may be made to FIG. 8. For example, various components and functions in FIG. 8 may be combined, further subdivided, replicated, omitted, or rearranged according to particular needs. Also, one or more additional components and functions may be included if needed or desired.

FIG. 9 illustrates an example multi-frame feature fusion architecture 900 supporting image processing for end to end multi-frame super-resolution according to this disclosure. For example, the multi-frame feature fusion architecture 900 may be used as part of the AI model architecture 500 of FIG. 5, such as in the multi-frame feature fusion 530. The multi-frame feature fusion architecture 900, however, may be used in other suitable architectures.

As shown in FIG. 9, the multi-frame feature fusion architecture 900 includes receiving an input frame 902 at a first reshaping process 910 to reshape the input frame 902 before providing the input frame 902 to a simple gated attention model 920 to produce a simple gated attention output 922. The simple gated attention output 922 is provided to a channel attention 930 to generate a channel attention output 932. The simple gated attention output 922 and the channel attention output 932 of the simple gated attention model 920 and the channel attention 930 are combined using a skip connection 924 before undergoing a second reshaping process 912 to generate a feature fusion output 940.

The multi-frame feature fusion architecture 900 introduces multi-frame fusion and dimensionality reduction to combine contextual information across frames while reducing computational overhead. In the multi-frame feature fusion architecture 900, input features of all burst frames are reshaped so that the features from all frames are placed in the channel dimension. Simple gated attention is then applied to reduce dimensionality while extracting contextual information. The result is fed into a dense channel attention block to weight channels that carry the most important contextual information. A skip connection is added to the channel attention output to aid training, and the outputs are then converted back to the original input shape with half the features, which in turn reduces computational cost.

Although FIG. 9 illustrates an example multi-frame feature fusion architecture 900 supporting image processing for end to end multi-frame super-resolution, various changes may be made to FIG. 9. For example, various components and functions in FIG. 9 may be combined, further subdivided, replicated, omitted, or rearranged according to particular needs. Also, one or more additional components and functions may be included if needed or desired.

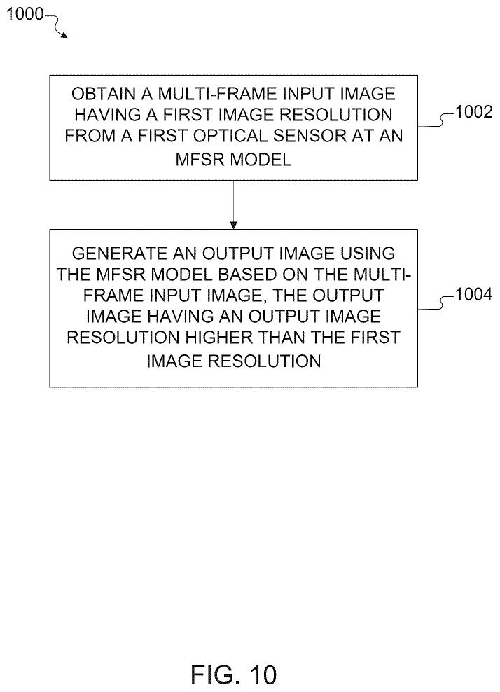

FIG. 10 illustrates an example method 1000 for image processing using a synthetic data engine and AI architecture for end to end multi-frame super-resolution according to this disclosure. For ease of explanation, the method 1000 is described as involving the use of the electronic device 101 of FIG. 1 supporting the AI model architecture 500 of FIG. 5. However, the method 1000 may be used with any other suitable image processing architecture, and the method 1000 may be used with any other suitable device (such as the server 106) or a combination of devices (such as the electronic device 101 and the server 106) and in any other suitable system(s).

As shown in FIG. 10, a multi-frame input image is obtained having a first image resolution from a first optical sensor at a MFSR model in step 1002. For example, the RAW burst frames 502 may be obtained at the electronic device 101, such as when the RAW burst frames 502 are captured using one or more imaging sensors 180 of the electronic device 101. The RAW burst frames 502 may optionally undergo pre-processing, such as registration and/or blending.

An output image is generated using the MFSR model based on the multi-frame input image, the output image having an output image resolution higher than the first image resolution in step 1004. For example, the RAW burst frames 502 may be provided to the AI model architecture 500, such as to the autoencoder 510, to generate the output image 552.

Generating the output image using the MFSR model based on the multi-frame input image may include generating input features based on the multi-frame input image using a multi-scale BFE and generating a fused feature output using multi-frame feature fusion based on the input features. Generating the output image using the MFSR model may also include constructing an intermediate output image using a residual feature block using the fused feature output and generating the output image by upsampling the intermediate output image. Additionally or alternatively, before generating the output image by upsampling the intermediate output image, a loss may be calculated between a ground truth and the intermediate output image that is backpropagated to update the MFSR model.

Generating the fused feature output using the multi-frame feature fusion based on the input features may include generating channel features by reshaping the aligned features into a channel dimension and reducing a dimensionality of the channel features using a gated attention model. Generating the fused feature output using the multi-frame feature fusion based on the input features may also include extracting contextual information from the channel features and determining a weight of the channel features based on the contextual information before converting the channel features back to an original input shape.

Although FIG. 10 illustrates one example of a method 1000 for image processing using a synthetic data engine and AI architecture for end to end multi-frame super-resolution, various changes may be made to FIG. 10. For example, while shown as a series of steps, various steps in FIG. 10 may overlap, occur in parallel, occur in a different order, or occur any number of times (including zero times).

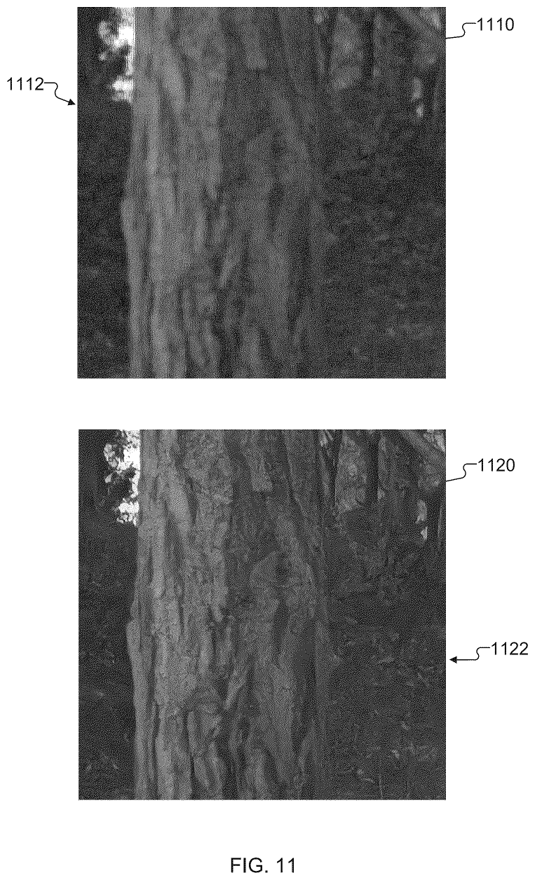

FIG. 11 illustrates example images with and without image processing using a synthetic data engine and AI architecture for end to end multi-frame super-resolution according to this disclosure. As shown in FIG. 11, a first image 1110 represents an image of a scene generated using conventional super resolution image processing. As can be seen here, the first image include a first resolution 1112 that does not clearly identify features within an object. In contrast, a second image 1120 represents an image of the same scene generated using the techniques described above. As can be seen here, the techniques described above improve the image resolution (such as at a second resolution 1122) to identify features of the object more clearly. This indicates that there is improved resolution of objects within the second image 1120 as compared to the first image 1110.

Although FIG. 11 illustrates one example of images 1120, 1110 with and without image processing using a synthetic data engine and AI architecture for end to end multi-frame super-resolution, various changes may be made to FIG. 11. For example, FIG. 11 is merely meant to illustrate one example of a type of benefit that might be obtained using the techniques of this disclosure. The specific results that are obtained in any given situation can vary based on the circumstances and based on the specific implementation of the techniques described in this disclosure.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method, comprising:
obtaining, by at least one processor of an electronic device, a multi-frame input image having a first image resolution from a first optical sensor at a multi-frame super-resolution (MFSR) model; and
generating, by the at least one processor, an output image using the MFSR model based on the multi-frame input image, the output image having an output image resolution higher than the first image resolution.

2. The method of claim 1, wherein generating the output image using the MFSR model based on the multi-frame input image comprises:
generating input features based on the multi-frame input image using a multi-scale base frame enhancement (BFE) architecture;
generating a fused feature output using multi-frame feature fusion based on the input features;
constructing an intermediate output image using a residual feature block using the fused feature output; and
generating the output image by upsampling the intermediate output image.

3. The method of claim 2, wherein the multi-scale BFE architecture is configured to:
generate a residual difference computation based on a difference between features of a non-reference frame of the multi-frame input image and a reference frame of the multi-frame input image; and
generate aligned features aligning features of the non-reference frame to the reference frame based on the residual difference computation using a hybrid gated attention model.

4. The method of claim 3, wherein generating the fused feature output using the multi-frame feature fusion based on the input features comprises:
generating channel features by reshaping the aligned features into a channel dimension;
reducing a dimensionality of the channel features using a gated attention model;
extracting contextual information from the channel features;
determining a weight of the channel features based on the contextual information; and
converting the channel features back to an original input shape.

5. The method of claim 2, further comprising:
before generating the output image by upsampling the intermediate output image, calculating a loss between a ground truth and the intermediate output image; and
backpropagating the loss to update the MFSR model.

6. The method of claim 1, wherein the MFSR model is trained to align features using a training pair having short-exposure frames and long-exposure frames, wherein a source image of the short-exposure frames is different from a source image of the long-exposure frames.

7. The method of claim 2, wherein the MFSR model is trained based on a database of homography matrices representing a transformation from a reference frame to a non-reference frame.

8. An electronic device, comprising:
at least one processor configured to:
obtain, by at least one processor of an electronic device, a multi-frame input image having a first image resolution from a first optical sensor at a multi-frame super-resolution (MFSR) model; and
generate, by the at least one processor, an output image using the MFSR model based on the multi-frame input image, the output image having an output image resolution higher than the first image resolution.

9. The electronic device of claim 8, wherein, to generate the output image using the MFSR model based on the multi-frame input image, the at least one processor is configured to:
generate input features based on the multi-frame input image using a multi-scale BFE architecture;
generate a fused feature output using multi-frame feature fusion based on the input features;
construct an intermediate output image using a residual feature block using the fused feature output; and
generate the output image by upsampling the intermediate output image.

10. The electronic device of claim 9, wherein to the multi-scale BFE architecture is configured to:
generate a residual difference computation based on a difference between features of a non-reference frame of the multi-frame input image and a reference frame of the multi-frame input image; and
generate aligned features aligning features of the non-reference frame to the reference frame based on the residual difference computation using a hybrid gated attention model.

11. The electronic device of claim 10, wherein, to generate the fused feature output using the multi-frame feature fusion based on the input features, the at least one processor is configured to:
generate channel features by reshaping the aligned features into a channel dimension;
reduce a dimensionality of the channel features using a gated attention model;
extract contextual information from the channel features;
determine a weight of the channel features based on the contextual information; and
convert the channel features back to an original input shape.

12. The electronic device of claim 9, wherein the at least one processor is further configured to:
before generating the output image by upsampling the intermediate output image, calculate a loss between a ground truth and the intermediate output image; and
backpropagate the loss to update the MFSR model.

13. The electronic device of claim 8, wherein the MFSR model is trained to align features using a training pair having short-exposure frames and long-exposure frames, wherein a source image of the short-exposure frames is different from a source image of the long-exposure frames.

14. The electronic device of claim 9, wherein the MFSR model is trained based on a database of homography matrices representing a transformation from a reference frame to a non-reference frame.

15. A non-transitory machine-readable medium containing instructions that when executed cause at least one processor of an electronic device to:
obtain a multi-frame input image having a first image resolution from a first optical sensor at a multi-frame super-resolution (MFSR) model; and
generate an output image using the MFSR model based on the multi-frame input image, the output image having an output image resolution higher than the first image resolution.

16. The non-transitory machine-readable medium of claim 15, wherein the instructions that when executed cause the at least one processor to generate the output image using the MFSR model based on the multi-frame input image comprise:
instructions that when executed cause the at least one processor to:
generate input features based on the multi-frame input image using a multi-scale BFE architecture;
generate a fused feature output using multi-frame feature fusion based on the input features;
construct an intermediate output image using a residual feature block using the fused feature output; and
generate the output image by upsampling the intermediate output image.

17. The non-transitory machine-readable medium of claim 16, wherein to the multi-scale BFE architecture is configured to:
generate a residual difference computation based on a difference between features of a non-reference frame of the multi-frame input image and a reference frame of the multi-frame input image; and
generate aligned features aligning features of the non-reference frame to the reference frame based on the residual difference computation using a hybrid gated attention model.

18. The non-transitory machine-readable medium of claim 17, wherein the instructions that when executed cause the at least one processor to generate the fused feature output using the multi-frame feature fusion based on the input features comprise:
instructions that when executed cause the at least one processor to:
generate channel features by reshaping the aligned features into a channel dimension;
reduce a dimensionality of the channel features using a gated attention model;
extract contextual information from the channel features;
determine a weight of the channel features based on the contextual information; and
convert the channel features back to an original input shape.

19. The non-transitory machine-readable medium of claim 16, wherein the instructions further comprise:
instructions that when executed cause the at least one processor to:
before generating the output image by upsampling the intermediate output image, calculate a loss between a ground truth and the intermediate output image; and
backpropagate the loss to update the MFSR model.

20. The non-transitory machine-readable medium of claim 15, wherein the MFSR model is trained to align features using a training pair having short-exposure frames and long-exposure frames, wherein a source image of the short-exposure frames is different from a source image of the long-exposure frames.
